(19) United States
(12) Patent Application Publication
(10) Pub. No.: US 2023/0409046 A1
(43) Pub. Date: Dec. 21, 2023

(54) AGENT PRIORITIZATION ON INTERPRETABLE RELATION FOR TRAJECTORY PREDICTION

(71) Applicant: Honda Motor Co., Ltd., Tokyo (JP)

(72) Inventors: Manh Trung HUYNH, Santa Clara, CA (US); Hengbo MA, Albany, CA (US); Chiho CHOI, San Jose, CA (US)

(21) Appl. No.: 18/080,637

(22) Filed: Dec. 13, 2022

Related U.S. Application Data
(60) Provisional application No. 63/352,588, filed on Jun. 15, 2022.

(51) Int. Cl. G05D 1/02

(52) U.S. Cl. CPC G05D 1/0287; G05D 1/0212; G05D 1/0274

(57) ABSTRACT

A system for trajectory prediction with agent prioritization is provided. A motion encoder is configured to determine future directions of agents of a plurality of agents and strengths of the agents based past trajectory information. The past trajectory information includes past trajectories of the agents at a number of time steps over a given time horizon for the agents. An inter-agent encoder is configured to determine the relations between the agents based on the future directions and the strengths. The relations identify motion impacts between the agents. The inter-agent encoder is further configured to calculate a motion prioritization score for each agent of the plurality of agents based on the relations between the agents. The motion prioritization scores define a priority order. The motion decoder is configured to calculate sequential predictions for future trajectories of the agents based on the motion prioritization scores.

### BACKGROUND

Multi-agent trajectory prediction is a component in a wide range of applications from robot navigation to autonomous intelligent systems. While navigating in crowded scenes, autonomous agents (e.g., robots and vehicles) not only themselves interact, but also may have an ability to observe others' interactions and anticipate where other agents will move in near future. However, existing paradigms of relation based trajectory prediction merely infer relations.

### BRIEF DESCRIPTION

According to one aspect, a system for trajectory prediction with agent prioritization is provided. The system includes a motion encoder, an inter-agent encoder, and a motion decoder. The motion encoder is configured to determine future directions of agents of a plurality of agents and strengths of the agents based on past trajectory information. The past trajectory information includes past trajectories of the agents at a number of time steps over a given time horizon for the agents. The inter-agent encoder is configured to determine the relations between the agents based on the future directions and the strengths. The relations identify motion impacts between the agents. The inter-agent encoder is further configured to calculate a motion prioritization score for each agent of the plurality of agents based on the relations between the agents. The motion prioritization scores define a priority order including a first priority agent having a highest priority score, a second priority agent having a second highest priority score, and an Nth priority agent having an Nth highest priority score. The motion decoder is configured to calculate sequential predictions for future trajectories of the agents based on the motion prioritization scores.

According to one aspect, a method for trajectory prediction with agent prioritization is provided. The method includes determining future directions of agents of a plurality of agents and strengths of the agents based on past trajectory information. The past trajectory information includes past trajectories of the agents at a number of time steps over a given time horizon for the agents. The method also includes determining the relations between the agents based on the future directions and the strengths. The relations identify motion impacts between the agents. The method further includes calculating a motion prioritization score for each agent of the plurality of agents based on the relations between the agents. The motion prioritization scores define a priority order including a first priority agent having a highest priority score, a second priority agent having a second highest priority score, and an Nth priority agent having an Nth highest priority score. The method yet further includes calculating sequential predictions for future trajectories of the agents based on the motion prioritization scores. The method includes causing at least one agent of the plurality of agents to navigate based on the future trajectories of the agents.

According to a further aspect, a non-transitory computer readable storage medium storing instructions that when executed by a computer having a processor to perform a method for trajectory prediction with agent prioritization is provided. The method includes determining future directions of agents of a plurality of agents and strengths of the agents based on past trajectory information. The past trajectory information includes past trajectories of the agents at a number of time steps over a given time horizon for the agents. The method also includes determining the relations between the agents based on the future directions and the strengths. The relations identify motion impacts between the agents. The method further includes calculating a motion prioritization score for each agent of the plurality of agents based on the relations between the agents. The motion prioritization scores define a priority order including a first priority agent having a highest priority score, a second priority agent having a second highest priority score, and an Nth priority agent having an Nth highest priority score. The method yet further includes calculating sequential predictions for future trajectories of the agents based on the motion prioritization scores. The method includes causing at least one agent of the plurality of agents to navigate based on the future trajectories of the agents.

### BRIEF DESCRIPTION OF THE DRAWINGS

FIG. 1 is an exemplary component diagram of a system for trajectory prediction with agent prioritization, according to one aspect.

FIG. 2A is an exemplary agent environment for trajectory prediction with agent prioritization, according to one aspect.

FIG. 2B is an exemplary generalized prediction map for trajectory prediction with agent prioritization, according to one aspect.

FIG. 2C is an exemplary priority map for trajectory prediction with agent prioritization, according to one aspect.

FIG. 3 is an exemplary process flow of a method for trajectory prediction with agent prioritization, according to one aspect.

FIG. 4A is an example network architecture for trajectory prediction with agent prioritization, according to one aspect.

FIG. 4B is an example network architecture for an inter-agent encoder with agent prioritization, according to one aspect.

FIG. 5 is an exemplary flow diagram corresponding to the exemplary process flow of a method for trajectory prediction with agent prioritization, according to one aspect.

FIG. 6 is an illustration of an example computer-readable medium or computer-readable device including processor-executable instructions configured to embody one or more of the provisions set forth herein, according to one aspect.

### DETAILED DESCRIPTION

A model is provided for multi-agent trajectory prediction that discovers interpretable relations among agents and prioritizes an agent's motion in the scenes. Typical paradigms infer the relations among agents using only their historical motions. The main limitation of these approaches is that they lack a mechanism to learn the motion importance of each agent in the scene. However, in realistically interactive scenarios, it is often that an agent's movements gains higher motion priority to decide where and when to move, as that agent's movements will impact the others in the scene. For example, in driving scenarios, pedestrians have higher motion priority than other agents, thus, vehicles must yield to crossing pedestrians by stopping or reducing speed. In a basketball scenario, an offensive player with ball may gain higher motion priority than other players. In other words, the other players' movements are likely to be conditioned (i.e., impacted) by the offensive player. Thus, in the systems and methods described herein, agent motions are prioritized based on interpretable relations.

Generally, the systems and methods described herein are focused on two movement behaviors: motion and navigation functions which capture the directions and strengths of agent movement, respectively. Agent motion priorities may then be calculated based on their relations. For example, in highly interactive scenarios, one agent may gain higher motion priority to move, while the motion of other agents may be impacted by the prioritized agent(s) having higher motion priority (e.g., a vehicle stopping or reducing its speed due to crossing pedestrians). Then, future trajectories may sequentially be predicted and iteratively updated for each agent based on the priority order and the learned relation structures.

In one embodiment, a motion encoder captures the relations between agents based on the past directions of agents and the strength of their movements. Next, a motion prioritization module determines a motion priority order that quantifies a motion priority score of each agent by measuring their motion impacts on other agents. Based on the priority order, the sequential predictions are made to allow the predicted future trajectories of agents with higher priorities to impact on the lower prioritized ones within their relation structures. Therefore, the systems and methods for trajectory prediction with agent prioritization provide a prediction pipeline with the motion prioritization module to prioritize each agent's importance based on the manner in which the agent's motion impacts the movements of other agents within their interpretable relation structures. The relationships among agents are learned interpretably at observed time steps of a time horizon to produce meaningful relation structures for prioritization task thereby enabling the systems and methods described herein to prioritize future trajectories based on the motion impacts between the agents of the plurality of agents.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Agent” as used herein are machines that move through or manipulate an environment. Exemplary agents may include, but is not limited to, robots, vehicles, or other self-propelled machines. The agent may be autonomously, semi-autonomously, or manually operated.

“Agent system,” as used herein may include, but is not limited to, any automatic or manual systems that may be used to enhance the agent, propulsion, and/or operation. Exemplary systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), an electronic pretensioning system, a monitoring system, a passenger detection system, a suspension system, a seat configuration system, a cabin lighting system, an audio system, a sensory system, an interior or exterior camera system among others.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” may refer to a remote device including a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle that is capable of carrying one or more users and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. Further, the term “vehicle” may refer to an electric vehicle (EV) that is powered entirely or partially by one or more electric motors powered by an electric battery. The term “vehicle” may also refer to an autonomous vehicle and/or self-driving vehicle powered by any form of energy.

### I. System Overview

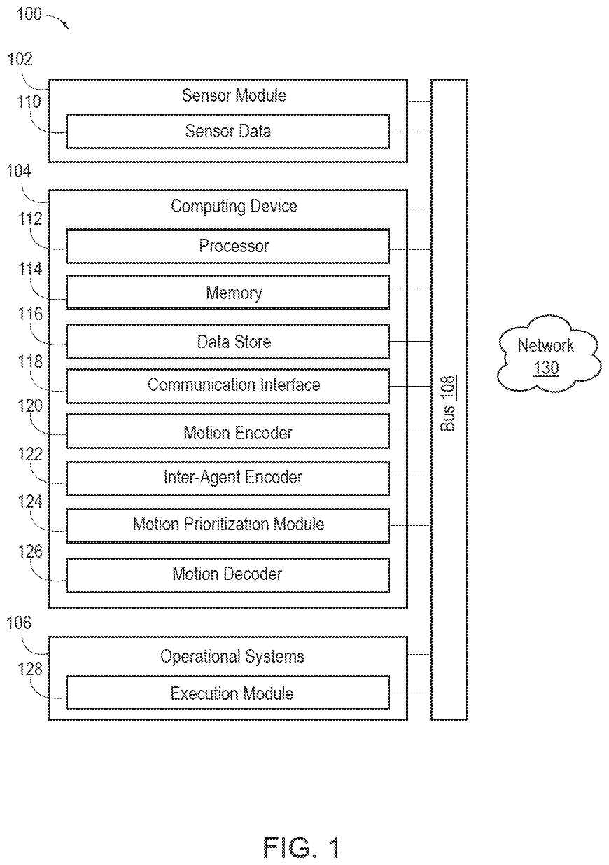

Referring now to the drawings, the drawings are for purposes of illustrating one or more exemplary embodiments and not for purposes of limiting the same. FIG. 1 is an exemplary component diagram of an operating environment 100 for trajectory prediction with agent prioritization, according to one aspect. The operating environment 100 includes a sensor module 102, a computing device 104, and operational systems 106 interconnected by a bus 108. The components of the operating environment 100, as well as the components of other systems, hardware architectures, and software architectures discussed herein, may be combined, omitted, or organized into different architectures for various embodiments. The computing device 104 may be implemented with a device or remotely stored.

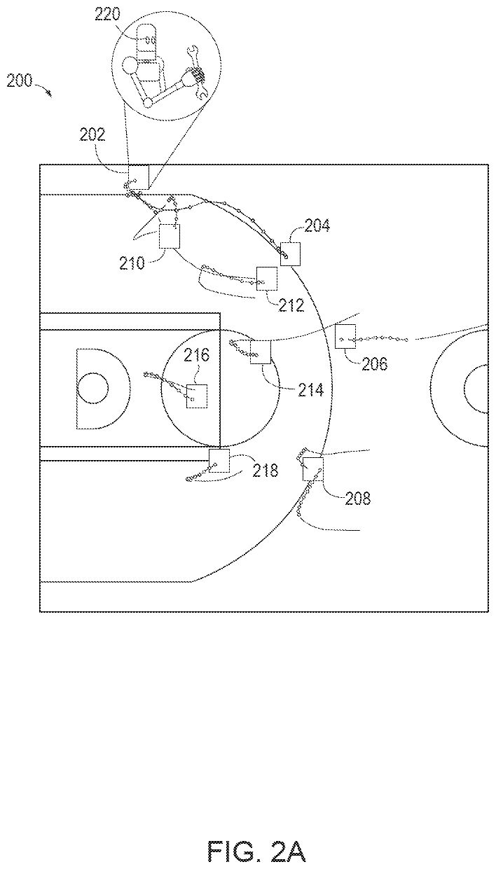

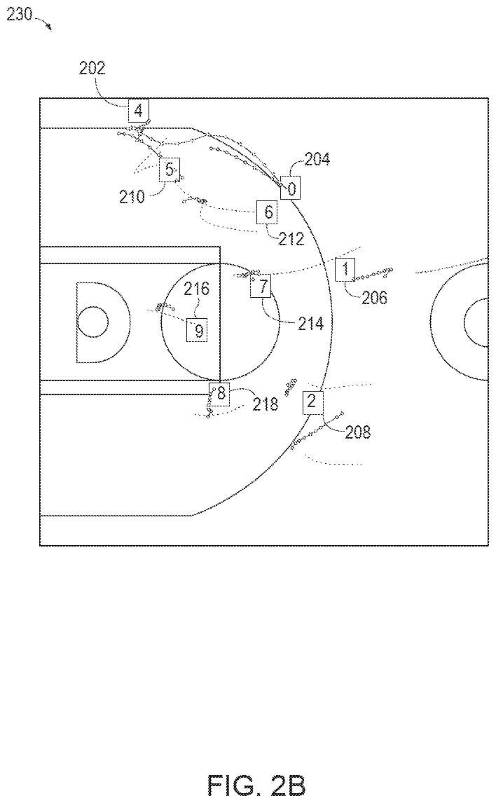

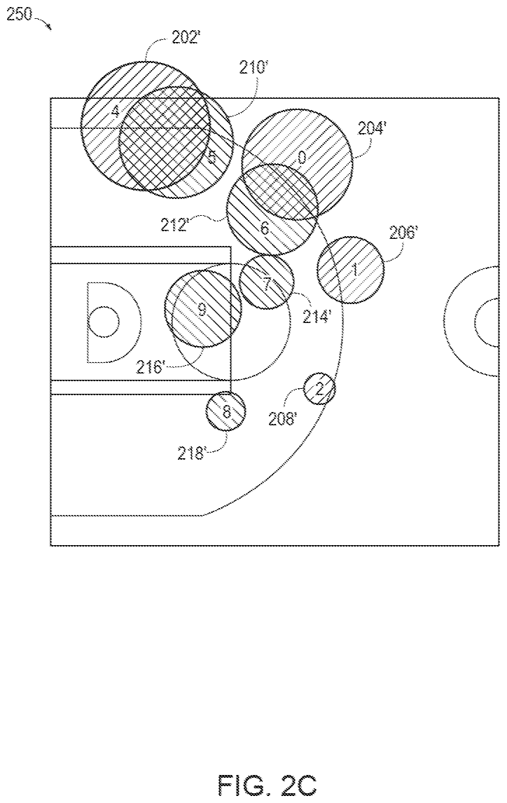

The computing device 104 may be implemented as a part of an ego agent, such as a first agent 202 of the plurality of agents 202-212 on half court 200, shown in FIGS. 2A-2C. An agent may be a bipedal, two-wheeled or four-wheeled robot, a vehicle, or a self-propelled machine. For example, in another embodiment, the first agent 202 may be configured as a humanoid robot. The first agent 202 may take the form of all or a portion of a robot. In a vehicular embodiment, the first agent 202 may be a vehicle configured to operate on a roadway. The computing device 104 may be implemented as part of a telematics unit, a head unit, a navigation unit, an infotainment unit, an electronic control unit, among others of the first agent 202. In other embodiments, the components and functions of the computing device 104 may be implemented with other devices (e.g., a portable device) or another device connected via a network (e.g., a network 130).

The computing device 104 may be capable of providing wired or wireless computer communications utilizing various protocols to send/receive electronic signals internally to/from components of the operating environment 100. Additionally, the computing device 104 may be operably connected for internal computer communication via the bus 108 (e.g., a Controller Area Network (CAN) or a Local Interconnect Network (LIN) protocol bus) to facilitate data input and output between the computing device 104 and the components of the operating environment 100.

An agent, such as the first agent 202, may include sensors for sensing objects and the environment, such as the half court 200. For example, the first agent 202 may include an image sensor 220. The image sensor 220 may be a light sensor to capture light data from around the first agent 202. For example, a light sensor may rotate 360 degrees around first agent 202 and collect the sensor data 110 in sweeps. Conversely, an image sensor 220 may be omnidirectional and collect sensor data 110 from all directions simultaneously. The image sensor 220 of an agent may emit one or more laser beams of ultraviolet, visible, or near infrared light toward the surrounding environment of the first agent 202.

The image sensor 220 may positioned on the first agent 202. For example, suppose that the first agent 202 is a vehicle. One or more sensors may be positioned at external front and/or side portions of the first agent 202, including, but not limited to different portions of the vehicle bumper, vehicle front lighting units, vehicle fenders, and the windshield. Additionally, the sensors may be disposed at internal portions of the first agent 202 including, in a vehicular embodiment, the vehicle dashboard (e.g., dash mounted camera), rear side of a vehicle rear view mirror, etc. Sensors may be positioned on a planar sweep pedestal (not shown) that allows the image sensor 220 to be rotated to capture images of the environment at various angles.

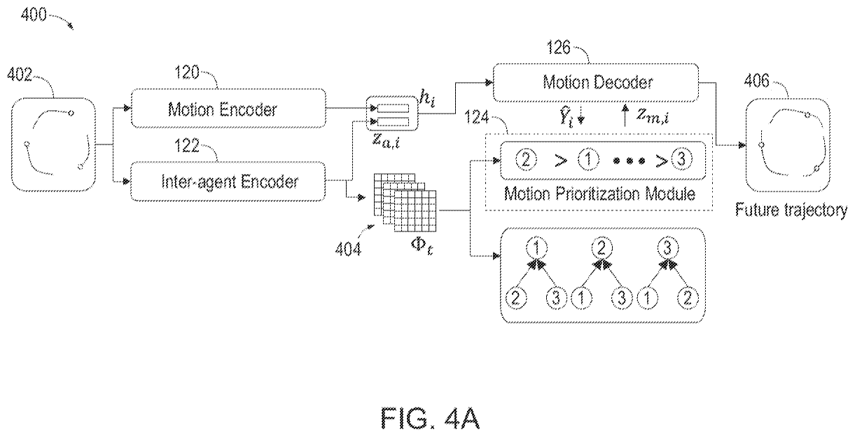

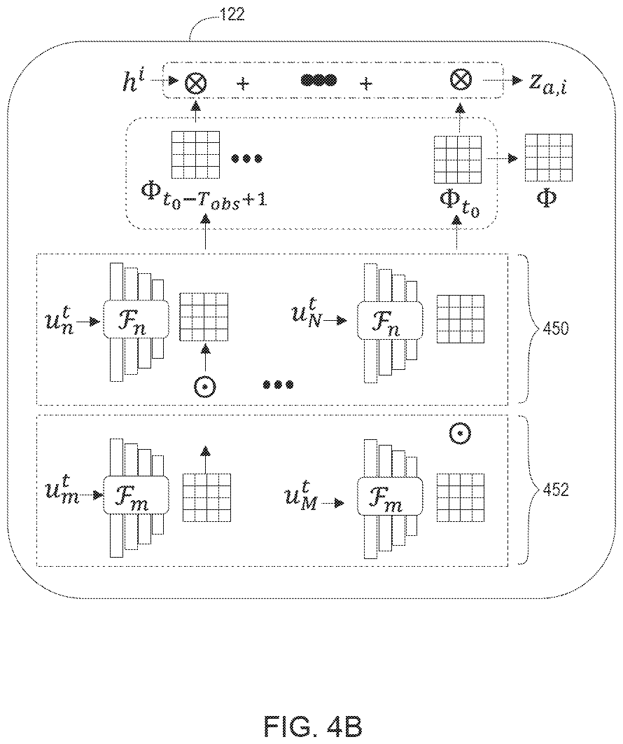

Accordingly, the sensors, such as the image sensor 220, and/or the sensor module 102 are operable to sense a measurement of data associated with the first agent 202, the operating environment 100, the environment, and/or the operational systems 106 and generate a data signal indicating said measurement of data. These data signals may be converted into other data formats (e.g., numerical) and/or used by the sensor module 102, the computing device 104, and/or the operational systems 106 to generate sensor data 110 including data metrics and parameters. The sensor data 110 may be received by the sensor module 102 may include past trajectory information 402 shown in FIG. 4A, such as past trajectories for agents of a plurality of agents 202-212. The past trajectories may include a path that an agent follows through space as a function of time, position data, and time step information, among others.

The computing device 104 includes a processor 112, a memory 114, a data store 116, and a communication interface 118, which are each operably connected for computer communication via a bus 108 and/or other wired and wireless technologies. The communication interface 118 provides software and hardware to facilitate data input and output between the components of the computing device 104 and other components, networks, and data sources, which will be described herein. Additionally, the computing device 104 also includes a motion encoder 120, an inter-agent encoder 122, a motion prioritization module 124, and a motion decoder 126 for trajectory prediction with agent prioritization facilitated by the components of the operating environment 100.

The motion encoder 120, the inter-agent encoder 122, the motion prioritization module 124, and/or the motion decoder 126 may be artificial neural networks that act as a framework for machine learning, including deep reinforcement learning. For example, motion encoder 120, the inter-agent encoder 122, the motion prioritization module 124, and/or the motion decoder 126 may be a convolution neural network (CNN). In one embodiment, the motion encoder 120, the inter-agent encoder 122, the motion prioritization module 124, and/or the motion decoder 126 may include a conditional generative adversarial network (cGAN). In some embodiments, the motion encoder 120, the inter-agent encoder 122, the motion prioritization module 124, and/or the motion decoder 126 are trained using highly interactive datasets such as the simulated Charged Particles dataset. Evaluations may be performed using real-world National Basketball Association (NBA) basketball model and an autonomous driving model.

Charged particles is a simulated deterministic system, which is controlled by simple physics rules. The simulated deterministic system generates scenes for interacting charged particles based on set parameters for training. For example, in a scene there may be five charged particles having either a positive or negative charge with equal probability. Particles with the same charge repel each other and vise versa. A time horizon may be set for each scene in order to generate a number of scenes based on, for example, eighty historic scenes and one hundred action scenes. Accordingly, using the historic scenes and the action scenes, a number of scenes may be generated for training, for example 50,000 scenes for training, and a number of scenes may be generated for validation, for example 10,000 scenes for validation and test.

The NBA dataset contains tracking data from the 2012-2013 NBA season. The dataset includes the trajectories of a ball and ten players from both teams such that each team includes five players. The data may be preprocessed such that each action scene has fifty frames and spans approximately eight seconds of play, and the first forty frames are historic. The autonomous driving model includes different realistic and interactive driving scenarios in roundabout, un-signalized intersection, signalized intersection, merging and lane changing. In total, the dataset may be collected from eleven locations using drones or fixed cameras.

The computing device 104 is also operably connected for computer communication (e.g., via the bus 108 and/or the communication interface 118) to one or more operational systems 106. The operational systems 106 may include, but are not limited to, any automatic or manual systems that may be used to enhance the first agent 202, operation, and/or propulsion. The operational systems 106 include an execution module 128. The execution module 128 monitors, analyses, and/or operates the first agent 202, to some degree. For example, the execution module 128 may store, calculate, and provide directional information and facilitate features like vectoring and obstacle avoidance among others. The execution module 128 may provide operational data to agent systems, such as the steering system, that cause the first agent 202 to operate autonomously. In some embodiments, the execution module 128 may be a Proportional, Integral, Derivative (PID) controller. The operational systems 106 may be dependent on the implementation.

The operational systems 106 also include and/or are operably connected for computer communication to the sensor module 102. For example, one or more sensors of the sensor module 102, such as the image sensor 220, may be incorporated with execution module 128 to monitor characteristics of the environment of the first agent 202 or the first agent 202 itself. For example, in a basketball embodiment, the image sensor 220 may be incorporated with execution module 128 to monitor characteristics of the half court 200. Suppose that the execution module 128 is facilitating a pick and roll. The execution module 128 may receive sensor data 110 from the sensor module 102 to confirm that another agent is available to receive a pass as expected.

The sensor module 102, the computing device 104, and/or the operational systems 106 are also operatively connected for computer communication to the network 130. The network 130 is, for example, a data network, the Internet, a wide area network (WAN) or a local area (LAN) network. The network 130 serves as a communication medium to various remote devices (e.g., databases, web servers, remote servers, application servers, intermediary servers, client machines, other portable devices). Detailed embodiments describing exemplary methods using the system and network configuration discussed above will now be discussed in detail.

II. Methods for Trajectory Prediction with Agent Prioritization

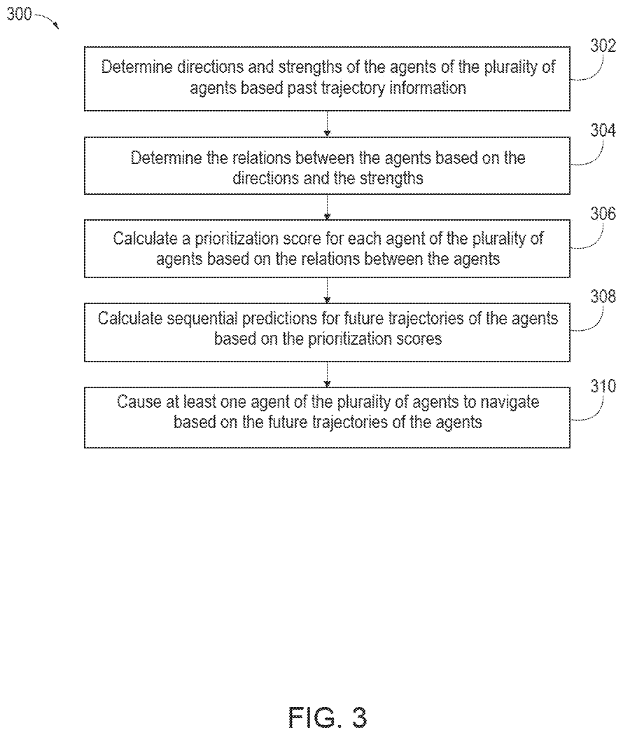

Referring now to FIG. 3, a method 300 for trajectory prediction with agent prioritization will now be described according to an exemplary embodiment. FIG. 3 will also be described with reference to FIGS. 1-2C, and 4A-6. For simplicity, the method 300 will be described as a sequence of elements, but it is understood that the elements of the method 300 may be organized into different architectures, blocks, stages, and/or processes.

At block 302, the method 300 includes the motion encoder 120 determining future directions of agents of a plurality of agents, N, and strengths of the agents based on past trajectory information 402. Turning to FIG. 2A, the plurality of agents includes a first agent 202, a second agent 204, a third agent 206, a fourth agent 208, a fifth agent 210, a sixth agent 212, a seventh agent 214, an eighth agent 216, and a ninth agent 218 in an environment, such as the half court 200.

Turning to FIG. 4A, the agents 202-218 are associated with past trajectory information 402, shown individually for each agent of the plurality of agents in FIG. 2A in solid arrows terminating at the respective agent. The past trajectory information includes the past trajectory information 402 of the agents at a number of time steps over a given time horizon for the agents. The past trajectory information 402 may be given by X=[X₁, X₂ . . . , X_{N}∈ [symbol] ^{T}^{₀}^{×d}]∈ [symbol] ^{N×T}^{₀}^{×d} of the N agents with d-dimensional spatial locations in the past T₀ time steps. Accordingly, the motion encoder 120 encodes historical motion data for each agent of the plurality of agents 202-218.

In one embodiment, the motion encoder 120 captures the individual movement of the agents 202-218 using a hidden motion feature h∈ [symbol] ^{N×d}^{ₕ} conditioned on X. The hidden state of each agent, i, may be given as:

eᵢ=ReLU(Conv1D(Xᵢ))∈ [symbol] ^{T}^{₀}^{×C}

[oᵢ^{t},hᵢ^{t}]=GRU(eᵢ),hᵢ^{t}∈ [symbol] ^{d}^{ₕ}

where hᵢ^{t} is the hidden motion state of an agent, i, at a current time step, t, oᵢ^{t} is the output feature of GRU, and C is the size of the embedded feature eᵢ.

The result of the motion encoder 120 is future directions of agents 202-218 of a plurality of agents, N, and strengths of the agents 202-218 based past trajectory information 402. The future directions and strengths of the agents 202-218 may be shown prediction map 230 are shown individually for each agent of the plurality of agents in FIG. 2B in dashed arrows extending from the respective agent. In this manner, the past trajectory information 402, the motion encoder 120 determines generalized future trajectories Y=[Y₁, Y₂ . . . , Y_{N}∈ [symbol] ^{T}^{₀}^{×d}]∈ [symbol] ^{N×T}^{₀}^{×d} in the next number of future time steps, T_{P}. The future trajectories include the future directions of the agents of the plurality of agents, N, and the strengths of the agents.

At block 304, the method 300 includes the inter-agent encoder 122 determines the relations 402, shown in FIG. 4A. The relations 402 are between the agents 202-218 based on the future directions and the strengths. The relations 402 identify motion impacts between the agents. The inter-agent encoder 122 encodes the motions between the agents 202-218 according to pₐ(zₐ, Φ|X). The inter-agent encoder 122 learns relation features zₐ based on the past trajectory information 402 and calculates relation matrices 404, Φ, including relation matrix Φ^{t}∈ [symbol] ^{N×N} at time steps t∈{t₀−Tₒ+1 . . . t₀}. Φ_{i,j}^{t} may be an asymmetric square matrix. The relations 404 may be learned during a training process via inducing sparsity loss.

The elements of the relation matrix, Φ_{i,j}^{t}, indicate the motion impact from agent i to agent j. The relation matrix value of relation matrix, Φ_{i,j}^{t}, is high if there is a strong motion impact from agent i to agent j. For example, where i represents the first agent 202 and j represents the second agent 204 and the relation matrix value of relation matrix 404, Φ_{i,j}^{t}, is high, then the first agent 202 has a strong motion impact on the second agent 204. Accordingly, the past trajectory information associated with the first agent 202 is able to be used for the future prediction of the second agent 204. Alternatively, if the relation matrix value of relation matrix 404, Φ_{i,j}^{t}=0, then the first agent 202 does not have a motion impact on the second agent 204. The relation matrix value of relation matrix 404, Φ_{i,j}^{t} is proportional to the motion impact between pairs of agents of the plurality of agents 202-218.

The inter-agent encoder 122 includes an interaction-based navigation encoder 450 given as Fₙ(Φₙ|X) and an interaction-based movement encoder 452 given as Fₘ(Φₘ|X) as shown in FIG. 4B. As the agents 202-218 may have similar navigation and movement functions, the agents 202-218 may have a similar ability to plan future movements. The navigation encoder 450 captures the relation based on the future directions of the agents 202-218. The movement encoder 452 infers the relation based on the strength of the movements of the agents 202-218. Then navigation encoder 450 and the movement encoder 452 may be implemented using neural networks, such as the self-explanatory neural network (SENN) and extensions thereof to determine causal relationships. For example, the networks may include a link function g(⋅), basis concepts ψ(x), and explainable function θ(x) for the predictions, such that the general format may be given by:

ƒ(x)=g(θ(x)₁ψ(x)₁, . . . ,θ(x)ᵤψ(x)ᵤ)

The basis concepts ψ(x) may be a motion feature hᵢ and the relation matrix Φₜ is the result of the explainable function θ(x) and the link function g(⋅), such that:

$$\\ {z}_{a , i}^{t} = {\sum }_{t = {t}_{0} - {T}_{o} + 1}^{{t}_{0}} {Φ}^{t} {h}_{i}^{t} + {ϵ}_{t} , {z}_{i} ∈ {}^{{d}_{a}}$$

Φ^{t} may be decomposed into Φₘ^{t} and Φₙ^{t} such that Φ^{t}=Φₘ^{t}⊙Φₙ^{t}, where ⊙ is element wise multiplication and ∈ₜ represents independent noise. Each matrix represents the agent relationships from motion and navigational perspectives. Φₘ^{t} and Φₙ^{t} are learned from motion and navigation functions as:

Φₘ^{t}=Fₘ^{t}(X^{t})∈ [symbol] ^{N d}^{ᵢ}^{×(N-1)d}^{ᵢ}

Φₙ^{t}=Fₙ^{t}(uₙ^{t})∈ [symbol] ^{N d}^{ᵢ}^{×(N-1)d}^{ᵢ},

where uₙ^{t}=[X^{t},r^{t}]∈ [symbol] ^{d}^{ᵤ} is the input feature concatenating the observed location X^{t} of the agents of the plurality of agents 202-218 and its relative locations to other agents of the plurality of agents 202-218 as r^{t}=[ΔX_{i,j(j≠i)}], and Fₘ and Fₙ are neural networks. Here, the model generalizes to real-word agent applications because the navigation functions are extended to capture relations 404 in both local and global scopes as:ββ

Fₙ(uⁿ)=ζ_{α}Fₙ^{l}(uₙ^{l})+(1−ζ_{α})Fₙ^{g}(uₙ^{g})

where Fₙ^{l} and Fₙ^{g} are both local and global navigation functions, which capture relations within local areas and the entire scene, respectively. The contribution of each function is weighted by ζₐ, a sigmoid function with learnable parameter α and ζ_{α}∈[0, 1]. While previous models infer the causal relationships without focusing on long-term trajectory prediction task, the systems and methods described herein focus on learning interpretable relation, which is meaningful for motion prioritization in the later stage and the entire pipeline is trained to improve the multi-step future prediction.

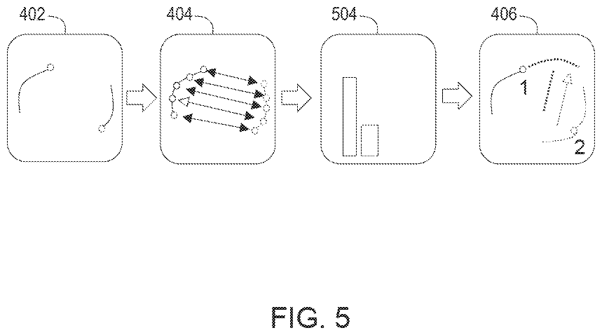

At block 306, the method 300 includes a motion prioritization module 124 calculating a motion prioritization score 504, shown in FIG. 5, for each agent of the plurality of agents 202-218 based on the relations 404 between the agents. The motion prioritization scores 504 define a priority order including a first priority agent having a highest priority score, a second priority agent having a second highest priority score, and an Nth priority agent having an Nth highest priority score.

The motion prioritization module 124, represented as pₘ(zₘ,r|Φ,Ŷ), prioritizes the impact of the agents of the plurality of agents 202-218 based on the learned relation matrix from the inter-agent encoder 122.

Given the learned relational matrix Φₜ at each observed time step t∈{t₀−Tₒ+1, . . . , t₀}, the relation matrix is quantified among the agents 202-218 according to S=∈ [symbol] ^{N×N} as:

$$\\ {S}_{i , j} = \frac{1}{{T}_{o}} {\sum }_{{t}_{0} - {T}_{o} + 1}^{{t}_{0}} κ ( t , {t}_{0} ) ( {‖ {Φ}_{i , j} ‖}_{2}^{2} ) ,$$

$$\\ {w}_{i , j}^{r} = \frac{{S}_{i , j}}{{\sum }_{j = 0 , j \neq i}^{P} {S}_{i , j}} ; {w}_{i , j} ∈ [ 0 , 1 ] ; {\sum }_{j \neq i}^{N} {w}_{i , j} = 1$$

where Φ=[(Φ^{t}^{₀}^{-T}^{ₒ}⁺¹, . . . , Φ^{t}^{₀}], including the relation matrix at each observed time step, and Φ^{t}=Φₙ^{t}⊙Φₘ^{t}. Due to the dynamic movements of agents 202-218, the recent relation matrix is more relevant to predict future time steps compared to those in further past. Therefore, the kernel κ(t, t₀)=ζₐ_{ᵣ}(1/|t₀−t|−dₜₕ) with ζₐ_{ᵣ} is asigmoid function with gain aᵣ is included. The kernel emphasizes the relation feature as it approaches the current time step, and weaken those that are further away. The future-conditioned relation feature z_{m,i} of target agent i is constructed as:

[symbol]

=GRU(Conv1D(Ŷⱼ))∈ [symbol] ^{d}^{ₕ}

z_{m,i}=w_{i,j}^{r}× [symbol] ∈ [symbol] ^{d}^{_{z}}

An agent of the plurality of agents 202-218 gains higher motion priority when that agent's motion is less affected by the motion of the other agents of the plurality of agents 202-218 so the motion prioritization score increases. Also, the agent gains a higher motion priority the more that the agent's motion impacts other agents of the plurality of agents 202-218. The impact is measured by calculating an impact score based on the relation matrix. Each agent is associated with a priority score mᵢ=Σ_{j=0,j≠i}^{j=N}S_{i,j}. The priority score is a value. For example, as shown in the prediction map 230 of FIG. 2B, the first agent 202 is associated with a priority score of 4, the second agent 204 is associated with a priority score of 0, the third agent 206 is associated with a priority score of 1, the fourth agent 208 is associated with a priority score of 2, the fifth agent 210 is associated with a priority score of 5, the sixth agent 212 is associated with a priority score of 6, the seventh agent 214 is associated with a priority score of 7, the eighth agent 216 is associated with a priority score of 9, and the ninth agent is associated with a priority score of 8. The priority scores may be relative to one another. For example, the motion prioritization scores define a priority order between the agents of the plurality of agents. For example, the second agent 204 may have the highest priority score of 0 and the third agent 206 may have the second highest priority score of 1, and so on to an Nth priority agent having an Nth highest priority score.

At block 308, the method 300 includes the motion decoder 126 calculating sequential predictions for future trajectories 406 of the agents based on the motion prioritization scores 504. In one embodiment, the motion decoder 126, represented as q(Ŷ|h), decodes the future trajectories 406 of each agent i from the learned hidden motion feature hᵢ^{t}. For example, the decoding process may be given by:

[oᵢ^{t+1},hᵢ^{t+1}]=GRU(hᵢ^{t})

[Δμᵢ^{t+1},σᵢ^{t+1},pᵢ^{t+1}]=fc(σᵢ^{t+1});μᵢ^{t+1}=μᵢ^{t}+Δμᵢ^{t+1}

Yᵢ^{t+1}˜N(μᵢ^{t+1},σᵢ^{t+1},pᵢ^{t+1})∈ [symbol] ^{d}^{ₕ}

where fc is a fully connected layer. To cope with multi-modal nature of future trajectories 406, the motion decoder 126 predicts a bivariate Gaussian distribution N(μᵢ^{t+1},σᵢ^{t+1},pᵢ^{t}) in each future time step t∈{t₀−Tₒ+1, . . . t₀+Tₚ}, where μᵢ^{t+1}=(μₓ,μ_{y})ᵢ^{t+1}, σᵢ^{t+1}=(σₓ,σ_{y})ᵢ^{t+1}, pᵢ^{t} are the mean, the standard deviation, and the correlation coefficient, respectively. In one embodiment, K number of samples are selected from a distribution for the final multiple trajectories prediction.

Due to complex interactions among the plurality of agents 202-218, relying on past trajectory information alone is not adequate for accurate predictions. Thus, the motion decoder 126 incorporates relation features from an inter-agent encoder 122 and from the motion prioritization module 124. The motion decoder 126 is formulated as q(Ŷ|h,zₐ, zₘ), where zₐ and zₐ are relation features from the inter-agent encoder 122. This is to allow the predicted trajectories of higher prioritized agents have impacts on the ones with lower priorities based on the motion prioritization scores 504. Accordingly, the motion decoder 126 is extended as q(Ŷ|h, zₐ, zₘ). In fact, the predicted trajectories of each agent may be updated (i.e., refined) multiple times to encourage the self-corrected among agent's future trajectories and to fully utilize the future-conditioned relation features.

The motion decoder 126 iteratively decodes the future trajectories 406 a predetermined number of times defined by Nₛ∈ [symbol] . If Nₛ=0, then there are no updates on predictions. In other words, the motion prioritization does not have effects. Otherwise, there will be Nₛ loop over the prioritized list [symbol] ={i, j, . . . , N}, where mᵢ≥mⱼ.

The predicted trajectories may be jointly trained and discover the relations as follows:

$$\\ ℒ ( θ ) = {\sum }^{{T}_{p}} {ℒ}_{pred} ( , {Y}_{t} ) + λ {\sum }^{{T}_{o}} {ℒ}_{sparsity} ( Φ )$$

$$\\ {ℒ}_{pred} = {min}_{k} ( {‖ {Y}_{\dot{i}} - {Y}_{i}^{\dot{k}} ‖}_{2} )$$

$$\\ {ℒ}_{sparsity} = \frac{1}{{T}_{o}} ( α {‖ Φ ‖}_{1} + ( 1 - α {‖ Φ ‖}_{F}^{2} )$$

where [symbol] _{pred} is the min-over-k mean-square-error (MSE) prediction loss, which encourages diversities among the K predictions sampled from the predicted Gaussian distribution. [symbol] _{sparsity}(Φₜ) sparsity-inducing penalty term used to learn the relation matrix and may act as an elastic—net—style penalty term with α=0.5, and where ∥⋅∥_{F} is the Frobenius norm.

At block 310, the method 300 includes the execution module 128 causing at least one agent of the plurality of agents to navigate based on the future trajectories 406 of the agents. Accordingly, a novel multi-agent trajectory prediction is provided that determines interpretable interaction feature from historical trajectories of each of the agents of the plurality of agents 202-212. The motion prioritization module 124 prioritizes those agents which have higher impacts on other future motions. Based on the motion prioritization scores 504, the motion decoder 126 makes sequential predictions for each agent with iterative predictions. In broader impacts, the sequential predictions could be used to infer relations in other scenarios such as human motions, or inferring agent-human interactions and predictions.

In some embodiments, the execution module 128 may determine a number of priority regions 202′-218′ and generate a priority map 250 as shown in FIG. 2C. The priority map 250 includes the number of priority regions 202′-218′ associated with each agent of the plurality of agents 202-218. For example, the first agent 202 is associated with the first priority region 202′, the second agent 204 is associated with the second priority region 204′, the third agent 206 is associated with the third priority region 206′, the fourth agent 208 is associated with the fourth priority region 208′, the fifth agent 210 is associated with the fifth priority region 210′, the sixth agent 212 is associated with the sixth priority region 212′, the seventh agent 214 is associated with the seventh priority region 214′, the eighth agent 216 is associated with the eighth priority region 216′, and the ninth agent 218 is associated with the ninth priority region 218′.

A priority region defines an area where the predicted future trajectories of the corresponding agent has priority in the environment for a number of time steps into the future. In an embodiment with multiple agents, an agent with a higher priority score takes precedence. For example, the first agent 202 may have priority for the predicted future trajectories in the first priority region 202′ relative to the fifth agent 210 because the first agent 202 has a higher priority score compared to the fifth agent 210. Therefore, where the first priority region 202′ overlaps with the fifth priority region 210′ in an overlapping region, the predicted future trajectories of the first agent 202 will be executed and the predicted future trajectories are adjusted to compensate for the motion of the first agent 202. Accordingly, the execution module 128 may cause at least one agent of the plurality of agents 202-218 to navigate based on the future trajectories 406 of the agents based on relative priority regions. In this manner, the future trajectories 406 are prioritized based on the motion impacts between the agents of the plurality of agents 202-218 because the relationships among agents are learned interpretably at observed time steps of a time horizon to produce meaningful relation structures for prioritization task.

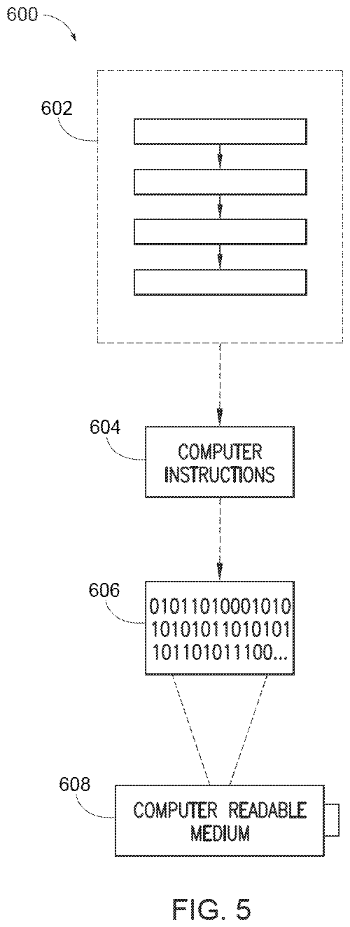

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the method 300 of FIG. 3. In another aspect, the processor-executable computer instructions 604 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for trajectory prediction with agent prioritization, the system comprising:
a motion encoder configured to determine future directions of agents of a plurality of agents and strengths of the agents based on past trajectory information, wherein the past trajectory information includes past trajectories of the agents at a number of time steps over a time horizon for the agents;
an inter-agent encoder configured to:
determine relations between the agents based on the future directions and the strengths, wherein the relations identify motion impacts between the agents, and
calculate a motion prioritization score for each agent of the plurality of agents based on the relations between the agents, wherein the motion prioritization scores define a priority order including a first priority agent having a highest priority score, a second priority agent having a second highest priority score, and an Nth priority agent having an Nth highest priority score; and
a motion decoder configured to calculate sequential predictions for future trajectories of the agents based on the motion prioritization scores.

2. The system for trajectory prediction with agent prioritization of claim 1, wherein the inter-agent encoder includes a navigation encoder configured to capture the relations based on the future directions of the agents of the plurality of agents.

3. The system for trajectory prediction with agent prioritization of claim 1, wherein the inter-agent encoder includes a movement encoder configured to capture the relations based on the strengths of the agents of the plurality of agents.

4. The system for trajectory prediction with agent prioritization of claim 1, wherein the motion decoder is configured to iteratively decode the future trajectories a predetermined number of times.

5. The system for trajectory prediction with agent prioritization of claim 1, wherein the system further comprises an execution module configured to determine priority regions corresponding to each agent of the plurality of agents, wherein a priority region defines an area of an environment where the predicted future trajectories of the corresponding agent have priority.

6. The system for trajectory prediction with agent prioritization of claim 5, wherein a first priority region corresponds to a first agent having a first priority score and a second priority region corresponds to a second agent having a second priority score, wherein the first priority region overlaps with the second priority region in an overlapping region, and wherein the first agent has priority in the overlapping region relative to the second agent when the first priority score is higher than the second priority score.

7. The system for trajectory prediction with agent prioritization of claim 5, wherein the execution module is further configured to generate a priority map including the priority regions.

8. A method for trajectory prediction with agent prioritization, the method comprising:
determining future directions of agents of a plurality of agents and strengths of the agents based on past trajectory information, wherein the past trajectory information includes past trajectories of the agents at a number of time steps over a time horizon for the agents;
determining relations between the agents based on the future directions and the strengths, wherein the relations identify motion impacts between the agents, and
calculating a motion prioritization score for each agent of the plurality of agents based on the relations between the agents, wherein the motion prioritization scores define a priority order including a first priority agent having a highest priority score, a second priority agent having a second highest priority score, and an Nth priority agent having an Nth highest priority score;
calculating sequential predictions for future trajectories of the agents based on the motion prioritization scores; and
causing at least one agent of the plurality of agents to navigate based on the future trajectories of the agents.

9. The method for trajectory prediction with agent prioritization of claim 8, wherein the relations are captured based on the future directions of the agents of the plurality of agents.

10. The method for trajectory prediction with agent prioritization of claim 8, wherein the relations are captured based on the strengths of the agents of the plurality of agents.

11. The method for trajectory prediction with agent prioritization of claim 8, wherein the future trajectories are iteratively decoded a predetermined number of times.

12. The method for trajectory prediction with agent prioritization of claim 8, the method further comprising determining priority regions corresponding to each agent of the plurality of agents, wherein a priority region defines an area of an environment where the predicted future trajectories of the corresponding agent have priority.

13. The method for trajectory prediction with agent prioritization of claim 12, wherein a first priority region corresponds to a first agent having a first priority score and a second priority region corresponds to a second agent having a second priority score, wherein the first priority region overlaps with the second priority region in an overlapping region, and wherein the first agent has priority in the overlapping region relative to the second agent when the first priority score is higher than the second priority score.

14. The method for trajectory prediction with agent prioritization of claim 12, the method further comprising generating a priority map including the priority regions.

15. A non-transitory computer readable storage medium storing instruction that when executed by a computer having a processor to perform a method for trajectory prediction with agent prioritization, the method comprising:
determining future directions of agents of a plurality of agents and strengths of the agents based on past trajectory information, wherein the past trajectory information includes past trajectories of the agents at a number of time steps over a given time horizon for the agents;
determining relations between the agents based on the future directions and the strengths, wherein the relations identify motion impacts between the agents, and
calculating a motion prioritization score for each agent of the plurality of agents based on the relations between the agents, wherein the motion prioritization scores define a priority order including a first priority agent having a highest priority score, a second priority agent having a second highest priority score, and an Nth priority agent having an Nth highest priority score;
calculating sequential predictions for future trajectories of the agents based on the motion prioritization scores; and
causing at least one agent of the plurality of agents to navigate based on the future trajectories of the agents.

16. The non-transitory computer readable storage medium implemented method of claim 15, wherein the relations are captured based on the future directions of the agents of the plurality of agents and the strengths of the agents of the plurality of agents.

17. The non-transitory computer readable storage medium implemented method of claim 15, wherein the future trajectories are iteratively decoded a predetermined number of times.

18. The non-transitory computer readable storage medium implemented method of claim 15, the method further comprising determining priority regions corresponding to each agent of the plurality of agents, wherein a priority region defines an area of an environment where the predicted future trajectories of the corresponding agent have priority.

19. The non-transitory computer readable storage medium implemented method of claim 18, wherein a first priority region corresponds to a first agent having a first priority score and a second priority region corresponds to a second agent having a second priority score, wherein the first priority region overlaps with the second priority region in an overlapping region, and wherein the first agent has priority in the overlapping region relative to the second agent when the first priority score is higher than the second priority score.

20. The non-transitory computer readable storage medium implemented method of claim 18, the method further comprising generating a priority map including the priority regions.
